(19) United States
(12) Patent Application Publication
(10) Pub. No.: US 2013/0319461 A1
(43) Pub. Date: Dec. 5, 2013

(54) Recycling Method for Waste Ceramic Filters

(71) Applicant: FAR EAST UNIVERSITY, Tainan City (TW)

(72) Inventors: Jenn-Shing WANG, Tainan City (TW); Rui-Dong LI, Tainan City (TW); Yu-Ching WANG, Tainan City (TW); Jia-Yu WU, Tainan City (TW)

(21) Appl. No.: 13/906,059

(22) Filed: May 30, 2013

(30) Foreign Application Priority Data
Jun. 1, 2012 (TW) 101119655

(51) Int. Cl. B01D 29/62

(52) U.S. Cl. CPC B01D 29/62
USPC 134/3

(57) ABSTRACT

Disclosed is a recycling method for waste ceramic filters, and the recycling method includes the steps of heating a waste ceramic filter that no longer has the oil filtering effect, applying an acid to the waste ceramic filter to remove unwanted substances attached on the filter, performing a washing or dewatering step to remove any acid solution remained on the ceramic filter, and performing a drying step to dry the ceramic filter.

### CROSS-REFERENCE TO RELATED APPLICATIONS

This application claims priority under 35 USC §119 to Taiwan Patent Application No. 101119655, filed on Jun. 1, 2012 in the Taiwan Intellectual Property Office (TIPO), the contents of which are herein incorporated by reference in their entirety.

### FIELD OF THE INVENTION

The present invention relates to a recycling method for waste ceramic filters, and more particularly to the method of using heat treatment and acid treatment processes to remove colloids and solid particles that cause a ceramic filter to lose its oil filtering effect.

### BACKGROUND OF THE INVENTION

In Taiwan, the technology of recycling waste lubricating oils is divided into recycle and simple recycle. The recycling technology includes: sulfuric acid—white clay technology, evaporation—white clay technology, evaporation—sulfuric acid—white clay technology, and the waste lubricating oil is recycled to a qualified base oil for lubrication, and such recycled lubricating oil is mainly used in professional recycling plants. The simple recycling technology includes removing impure substances (sedimentation, sedimentation—centrifugation, sedimentation—filtering, centrifugation, filtering, and flash evaporation—filtering), degassing, water rinsing, flocculation, and adsorptive refinement. The simple recycling technology is mainly provided for users to recycle the filters by themselves and produce recycled lubricating oil for their own use. The simple recycled lubricating oil usually does not comply with all requirements of the new oil specification, but it can be used together with new oil or used after adding additives.

At present, the technology of recycling waste oils is classified into the following three types. The first type is called purification including one or more of the processing steps such as sedimentation, centrifugation, filtering and flocculation, and it is basically the same as the simple recycling in the past, and it is mainly used for removing water in the waste oil, suspended mechanical impurities and stable scattered mechanical impurities in a colloidal form.

The second type is called refinement, wherein a chemical refinement or adsorptive refinement process is added on a purification basis. For example, the waste lubricating oil is purified to remove the impurities or flocculated, and then processed by the white clay refinement or sulfuric acid—white clay refinement, or chemical metal removal and demulsification to produce a metal manufacture solution, so that the processed oil can be used in a non-stringent conditions such as the lubricating oil, demolding oil, detergent solution or road cleaning oil.

The third type is called further refinement including a recycling process of evaporation such as the evaporation—white clay, evaporation acid—white clay, evaporation—hydrogenation for produce an oil quality in compliance with the requirements of natural base oils, preparing various different low-, mid- and high-end oils with a quality similar to that of oils produced from natural oils

In the aforementioned waste oil processing methods, two of them are used more extensively. One method is used for producing cleaning solutions or fuels with metals removed or road oils, and the other method is used for producing recycled lubricating oil. These two methods can satisfy the requirements of environmental protection and economic effect.

The recycle technology also has to take the issue of environmental pollution into consideration. Some of the recycle units and processes such as evaporation and hydrogenation do not have the issue of environmental pollution, and some of the recycle units and processes may give rise to environmental pollutions such as the waste solution produced by the flocculation, waste salt and wastewater produced by the salty water rinse, waste adsorbents produced by the adsorptive refinement process. If the waste products are not processed, discharged or dumped properly, there will be an issue of environmental pollution. Some recycle units or processes such as refinement by sulfuric acid, and thus causing pollutions to the environment or producing acid sludge. If the acid sludge is dumped improperly, the environment will be polluted seriously and sulfuric dioxide gas harmful to living organisms will be produced.

In recent years, the waste lubricating oil recycle industry becomes important due to the environment protection issues. Of course, pollutions caused by waste oils are intolerable, so that some sulfuric acid refiners are phased out, and pollution-free recycle technologies are developed. Even the current existing recycling plants adopting sulfuric acid refinement have found proper acid sludge handling methods to avoid jeopardizing the environment.

The most successful development of pollution-free recycling technology adopts film evaporation conducted in high-vacuum and low-temperature conditions to replace the sulfuric acid refinement method, and the base oils are evaporated without deteriorating the oils, and then processed by white clay or hydrogenation refinement to produce good-quality recycled base oils.

Some large-scale waste oil recycling plants adopt the pollution-free technologies, but there are still many major plants and small- and mid-scale plants using the sulfuric acid—white clay technology, and an effective three-step waste treatment method is used to provide an acceptable environmental protection measure.

As to purification, there is not much an environmental protection issue, and the environmental protection requirements can be satisfied with very little care.

Gas or engine oil must be filtered by a filter to remove impurities such as dust and metal particles to prevent the machineries from being damaged. However, the machineries will have dirt clogged in the filter after some time of use, so that the oil filtering quality will become gradually lower, and it is necessary to replace the filter timely to maintain the operating efficiency of the machineries. In general, the filter material is paper or adsorptive resin filter material which will have serious chemical reactions after the filter loses its effect, and such chemically reacted filter cannot be recycled or reused anymore. On the other hand, the ceramic filter cannot be reused after it loses its filtering function as the dirt clogs the filter, even though the filter has many advantages such as heat resistance, corrosion resistance, and high chemical stability. The main subject of the present invention is to recycle and reuse a waste ceramic filter by a ceramic filter recycling method.

### SUMMARY OF THE INVENTION

In view of the aforementioned problems of the prior art, it is a primary objective of the present invention to recycle and reuse resources by providing a recycling method for waste ceramic filters.

Another objective of To achieve the aforementioned objective, the present invention provides a recycling method for waste ceramic filters to overcome the issue of losing the oil filtering effect of a waste ceramic filter.

To achieve the aforementioned objectives, the present invention provides a recycling method for waste ceramic filters, comprising the following steps:

Provide a ceramic filter with a porous structure, wherein the porous structure of the ceramic filter has a pore size falling within a range of 0.5˜10 μm, an external diameter of 52 mm, an internal diameter of 38 mm, a length of 350 mm, and a shape being a hollow cylindrical shape, and the ceramic filter has solid particle, hydrocarbon or colloid attached thereon.

Carry out a heat treatment step to the ceramic filter to remove the hydrocarbon attached on the ceramic filter, wherein the heat treatment step take place at a processing temperature falling within a range of 300˜500□, and the ceramic filters are arranged vertically to facilitate the attached substances to flow downward by high heat and gravity and concentrate the residual attached substances at the bottom for an easy inspection to determine whether a thorough cleaning is needed and for a better quality control, and the heat treatment step takes place for approximately 10 to 100 minutes, and the hydrocarbon is turned into gas by thermal decomposition, so as to achieve the separation purpose.

Carry out to an acid treatment step to the ceramic filter, wherein an acid solution is provided for dissolving solid particles attached on the ceramic filter, and the acid solution has a pH value falling within a range from 2 to 6 and is processed for approximately 30 to 600 seconds, and the acid solution can be hydrochloric acid, sulfuric acid, nitric acid, or any combination of the above. The solid particle is mainly metal powder or dust that can be dissolved by the acid solution to an extent of removing the solid particle but not necessary to the extent of dissolving the solid particle completely.

Carry out a washing step to the ceramic filter, wherein the washing step is provided for washing away the acid solution remained on the ceramic filter; or carry out a centrifugal dewatering step to the ceramic filter to remove the acid solution remained on the ceramic filter, wherein the centrifuge speed is 500 rpm to 10000 rpm.

Carry out a drying step to the ceramic filter, wherein the ceramic filter is put and dried in a microwave oven or an oven with a power of 100˜800W and a temperature of 40˜200□ for 10˜100 minutes, or seal an end of filter cores and then blow waste hot air produced in the heat treatment step from the middle of filter cores, so that the hot air passes through interconnecting pores to carry away the moisture while taking the drying efficiency and power saving effect into consideration.

In summation, the recycling method for waste ceramic filters of the present invention has the following advantages:

(1) The recycling method for waste ceramic filters of the present invention can achieve the objective of recycling and reusing resources.

(2) The recycling method for waste ceramic filters of the present invention can remove solid particles and hydrocarbons attached on ceramic filters by a simple, easy, and low-cost processing procedure.

### BRIEF DESCRIPTION OF THE DRAWINGS

FIG. 1 is a flow chart of a recycling method for waste ceramic filters of the present invention;

FIG. 2 shows microscopic photos of ceramic filters taken before/after being processed by a recycling method for waste ceramic filters of the present invention;

FIG. 3 is a pore distribution versus diameter graph of a waste filter;

FIG. 4 is a pore distribution versus diameter graph of a processed filter; and

FIG. 5 is a SEM photo of a ceramic filter.

### DESCRIPTION OF THE PREFERRED EMBODIMENTS

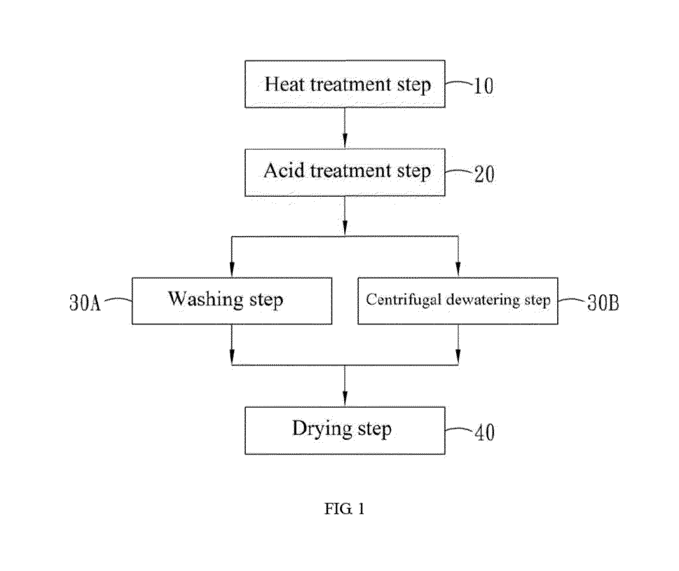

With reference to FIG. 1 for a flow chart of a recycling method for waste ceramic filters of the present invention, the recycling method for waste ceramic filters is applied to ceramic filter clogged by impurities or foreign matters, and the ceramic filter comes with a porous structure with a pore size of approximately 0.5˜10 μm, and the ceramic filter has solid particles, hydrocarbons or colloids attached onto its surface, and the solid particles are mainly metal particles or dust.

In the recycling method for waste ceramic filters of the present invention, the hollow cylindrical ceramic filter with an external diameter of 52 mm, an internal diameter of 38 mm, and a length of 350 mm is heated in a heat treatment step 10, wherein the ceramic filters are arranged vertically to facilitate attached substances to slide down from the surface of the ceramic filters by high temperature and gravity, so that the attached substances at a relatively upper position will carry away the attached substances at a relatively lower position by the weight and adhesiveness of the upper attached substances during the moving process to improve the separation efficiency. The main function of the heat treatment resides on the moving and thermal decomposition of the attached substances. The heat treatment step 10 takes place at a processing temperature falling within a range of 300˜500□ for a processing time falling within a range of 10˜100 minutes. Wherein, the heat treatment temperature preferably falls within a range of 400˜450□, and the heat treatment time preferably falls within a range of 10˜30 minutes. The heat treatment step 10 is mainly used for removing the hydrocarbon and colloid attached on the ceramic filter.

And then, an acid treatment step 20 is carried out for the ceramic filter, wherein the acid treatment step 20 uses an acid solution to dissolve solid particles attached onto the ceramic filter including the particles. in the interconnecting pores. Wherein the acid solution is hydrochloric acid, sulfuric acid, nitric acid or a combination of the above, and the acid solution has a pH value falling within a range from 2 to 6 and a dipping time of 30˜600 seconds.

And then, a washing step 30A is carried out for the ceramic filter, wherein clean water is used for washing away the acid solution remained on the ceramic filter, and the ceramic filter can be dipped or rinsed, and the quantity of remained acid solution is approximately 8%, and a weak alkaline (with a pH value from 7.5 to 9) or a salt water is used to further neutralize the acid solution or form a buffer solution and reduce the remained acid solution below 2%.

Alternatively, a centrifugal dewatering step 30B is carried out. For example, the ceramic filter is centrifuged to remove the acid solution and particles stuck in the pores. Since the porous material may cause the solution remained on the surface due to surface tension and remained in the pores, and the centrifuge can remove water from the surface quickly or water from the pores, and reduce the remained acid solution to a level below 2%. Clean water can be rinsed in a direction opposite to the filtering direction of the ceramic filter, and further reduce the level of acid solution and moisture in the ceramic filter and facilitate the later drying step. in other words, the centrifugal dewatering step is to remove residual acid solution and particles by centrifugal dewatering method, and the direction of dewatering water is opposite to the filtering direction, and the centrifuge speed is 500˜10000 rpm, while clean water is added in the cylindrical are during the centrifuge process to wash the interconnecting pores to facilitate washing away the residual acid solution and particles to reduce the quantity of residual acid solution below 0.1%.

Finally, a drying step 40 is carried out for the ceramic filter to dry the ceramic filter. In the drying step, the ceramic filter is put into a microwave oven or an oven with a power of 100˜800W at a temperature of 40˜200□ for 10˜100 minutes, or the drying method is to seal an end of filter cores, and then waste hot air produced in the heat treatment step is blown from the middle of the filter cores, wherein hot air is passed through the interconnecting pores to carry away the moisture while improving the drying efficiency and saving power.

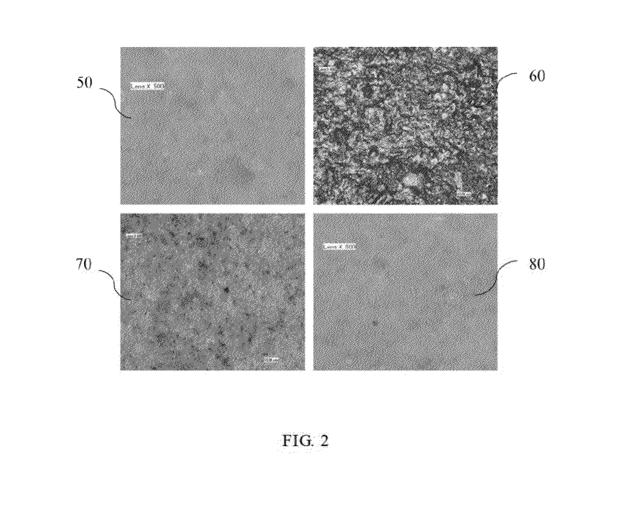

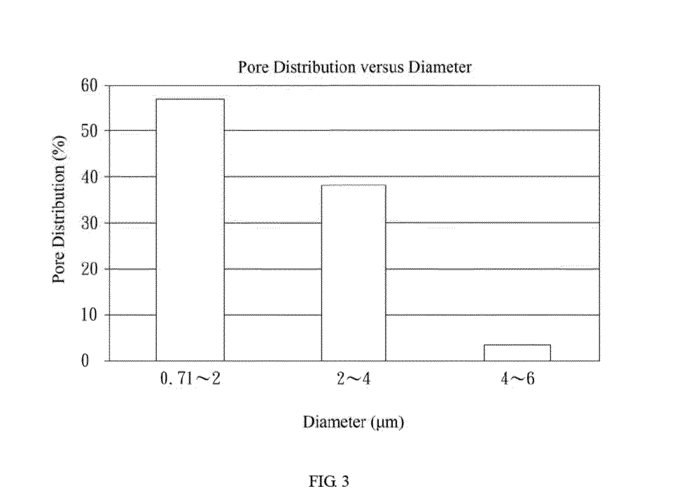

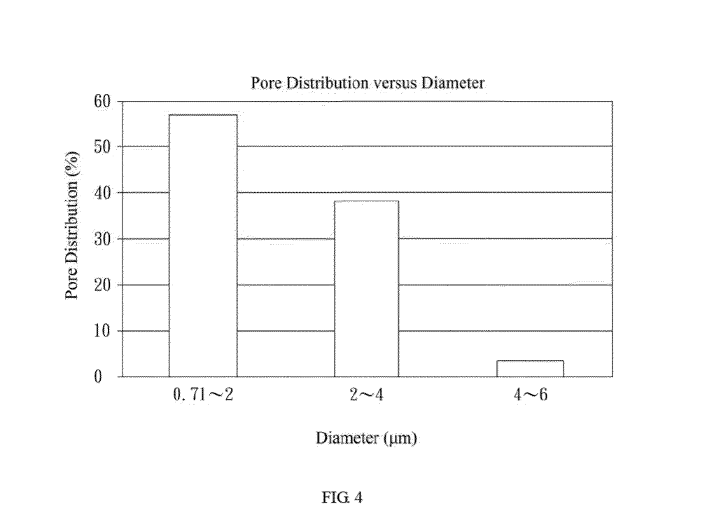

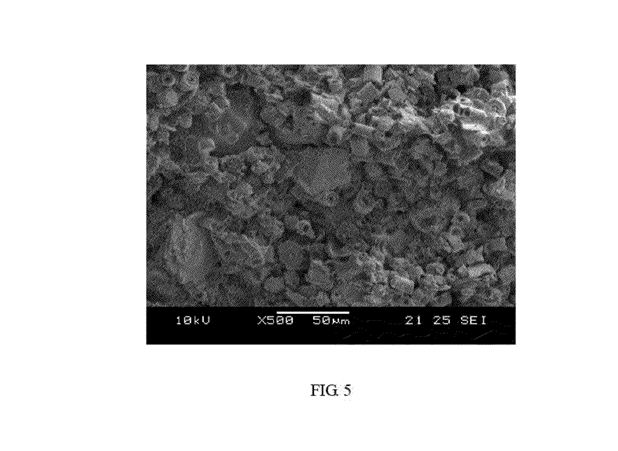

With reference to FIGS. 2 to 5, the numeral 50 represents a microscopic structure of the original ceramic filter, the numeral 60 represents a microscopic structure of a waste ceramic filter, the numeral 70 represents a microscopic view of a ceramic filter 60 that has been processed by the heat treatment step, the numeral 80 represents a microscopic structure of a ceramic filter 70 that has been processed by an acid treatment step.

In FIG. 2, more solid particles are attached onto the surface of the ceramic filter 60 than the ceramic filter 50, so that the ceramic filter 60 loses the oil filtering effect. In the recycling method for waste ceramic filters of the present invention, the ceramic filter 60 is processed by the heat treatment step, and then the solid particles clogged on the surface of the ceramic filter 70 can be improved significantly. And then, an acid treatment step is carried out for the ceramic filter 70, and clogged solid particles no longer exist on the surface of the ceramic filter 80, wherein the solid particles are generally metal and dust. Therefore, the waste ceramic filter 60 without the oil filtering effect can be reused after the solid particles attached onto the ceramic filter are removed by the recycling method for waste ceramic filters of the present invention.

What is claimed is:

1. A recycling method for waste ceramic filters, used for removing attached substances from the ceramic filters, comprising:
a heat treatment step for removing hydrocarbons and colloids on the ceramic filters by heat, wherein the ceramic filters are arranged vertically in an oven;
an acid treatment step for dipping solid particles attached on the ceramic filters to dissolve the solid particles by an acid solution;
a washing step for washing away the acid solution remained on the ceramic filters; and
a drying step for drying the ceramic filters.

2. The recycling method for waste ceramic filters according to claim 1, wherein the heat treatment step has a processing temperature ranging from 300° C. to 500° C., and a processing time ranging from 10 minutes to 100 minutes.

3. The recycling method for waste ceramic filters according to claim 1, wherein the acid solution has a pH value ranging from 2 to 6, and the acid solution is selected from the group consisting of hydrochloric acid, sulfuric acid and nitric acid.

4. The recycling method for waste ceramic filters according to claim 1, wherein the washing step adopts a weak alkaline solution, salt water or water for rinsing.

5. The recycling method for waste ceramic filters according to claim 1, wherein the ceramic filters each has an interconnecting pore structure with a pore size ranging from 0.5 μm to 10 μm.

6. The recycling method for waste ceramic filters according to claim 1, wherein the drying step adopts a microwave heating method for heating the ceramic filters in an oven or blowing waste hot air from the middle of filter cores with a power from 100W to 800W, a temperature from 40° C. to 200° C., and a drying time from 10 minutes to 100 minutes.

7. A recycling method for waste ceramic filters, comprising:
a heat treatment step for removing hydrocarbons and colloids attached on the ceramic filters by heating in an oven, wherein the ceramic filters are arranged vertically in the oven;
an acid treatment step for dissolving solid particles attached on the ceramic filters by an acid solution;
a centrifugal dewatering step for removing the remained acid solution and the solid particles stuck in pores by a centrifugal dewatering method, wherein the dewatering direction is opposite to the filtering direction, while clean water is used for washing interconnecting pores in a hollow cylindrical area during the centrifugal dewatering step; and
a drying step for removing water remained on the ceramic filters.

8. The recycling method for waste ceramic filters according to claim 7, wherein the heat treatment step has a processing temperature range from 300° C. to 500° C. and a processing time from 10 minutes to 100 minutes.

9. The recycling method for waste ceramic filters according to claim 7, wherein the acid solution has a pH value ranging from 2 to 6, and the acid solution is selected from the group consisting of hydrochloric acid, sulfuric acid and nitric acid.

10. The recycling method for waste ceramic filters according to claim 7, wherein the centrifugal dewatering step adopts a solution which is a weak alkaline solution, salt water or water, and a centrifuge speed from 500 rpm to 10000 rpm.

11. The recycling method for waste ceramic filters according to claim 7, wherein the ceramic filters has an interconnecting pore structure with a pore size ranging from 0.5 μm to 10 μm.

12. The recycling method for waste ceramic filters according to claim 7, wherein the drying step adopts a microwave heating method for heating the ceramic filters in an oven or blowing waste hot air from the middle of filter cores.
